(19) United States
(12) Patent Application Publication
(10) Pub. No.: US 2024/0217423 A1
(43) Pub. Date: Jul. 4, 2024

(54) WHEEL RETAINING APPARATUS, KIT, AND METHODS OF USING THE SAME

(71) Applicant: Anderson Kenneth FORTNER, Smithville, TN (US)

(72) Inventor: Anderson Kenneth FORTNER, Smithville, TN (US)

(21) Appl. No.: 18/399,142

(22) Filed: Dec. 28, 2023

Related U.S. Application Data
(60) Provisional application No. 63/436,927, filed on Jan. 4, 2023.

(51) Int. Cl. B60P 3/077

(52) U.S. Cl. CPC B60P 3/077

(57) ABSTRACT

The disclosure relates to wheel retaining apparatuses, kits, and methods of using the same. The wheel retaining apparatus may be used to secure and/or transport any number of wheeled machines.

### CROSS-REFERENCE TO RELATED APPLICATIONS

This application claims the benefit of Provisional Patent Application No. 63/436,927, filed on Jan. 4, 2023, which is hereby incorporated by reference in its entirety for all purposes.

### FIELD

The disclosure relates to a wheel retaining system and apparatus for retaining wheeled machines on a platform, thereby preventing the machine from moving while in transport.

### BACKGROUND

Wheeled machines, such as lawn mowers, 4-wheelers, construction equipment, bicycles, etc. transported on platforms such as trailers are particularly prone to damage due to not being secured properly. Thus, there is a need for an apparatus that can be customized to the size of the wheel on the machine to be transported to effectively prevent it from rolling backwards or forwards into another machine or off the platform.

The foregoing examples of related art and limitations related therewith are intended to be illustrative and not exclusive, and they do not imply any limitations on the disclosure presented herein. Other limitations of the related art will become apparent to those skilled in the art upon a reading of the specification and a study of the drawings.

### SUMMARY

The following embodiments and aspects thereof are described and illustrated in conjunction with systems, tools and methods, which are meant to be exemplary and illustrative, not limiting in scope.

In some embodiments, the disclosure relates to a wheel retaining apparatus for retaining a wheeled machine relative to a platform, comprising: a rebar having a first end, a second end, and a length; and a pair of brackets each comprising: a first channel member with an extended length for positioning on and affixation to a platform, and a second channel member affixed to the first channel member and extending out from the first channel member at an angle thereto; wherein: the pair of brackets are spaced apart from one another a first distance, the first distance being between 4 and 96 inches; the distance between the brackets is such that the established space between the brackets is configured to receive at least one wheel of a wheeled machine; the rebar is curved at the first end and the length is greater than the first distance between the pair of brackets; the second channel member of each bracket includes at least one opening spaced apart from the base at a second distance; the opening of each second channel member is configured to receive and retain the retaining rod, such that, upon at least one wheel being received between the pair of brackets, the second end of the retaining rod is inserted within the opening of a first of the pair of brackets, and then received within the opening of a second of the pair of brackets so as to retain the at least one wheel of the wheeled machine between the pair of brackets.

In some embodiments, the disclosure relates to a wheel retaining apparatus for retaining a wheeled machine relative to a platform comprising: a first retaining rod having a first end, a second end, and a length; and a pair of brackets each comprising: a first channel member with an extended length for positioning on and affixation to a platform, and a second channel member affixed to the first channel member and extending out from the first channel member at an angle thereto; wherein: the pair of brackets are spaced apart from one another a first distance, the first distance between the brackets is such that the established space between the brackets is configured to receive at least one wheel of a wheeled machine; the length of the first retaining rod is greater than the first distance between the pair of brackets; the second channel member of each bracket includes a means for releasably coupling the first retaining rod, such that, upon at least one wheel of a wheeled machine being received between the pair of brackets, the first retaining rod is releasably coupled to the second channel member so as to retain the at least one wheel of the wheeled machine between the pair of brackets.

In some embodiments, the disclosure relates to a kit for retaining a wheeled machine on a platform comprising: a first retaining rod having a first end, a second end, and a length; a pair of first and second channel members, wherein each first channel member has an extended length for positioning on and affixation to a platform, and each second channel member has a means for releasably coupling the retaining rod; at least one fastener for affixing each of the first and second channel members together and/or affixing each of the first channel members to the platform; and instructions for installation and use, wherein the instructions comprise directions for: affixing each first and second channel member together at an angle thereto to form a pair of brackets; affixing the second channel member of each bracket to a platform at a distance, orientation, and position so as to retain a wheeled machine when at least one wheel, being received between the pair of brackets, is prevented from rolling when the retaining rod is releasably coupled to each second channel member.

In some embodiments, the disclosure teaches a method for transporting a wheeled machine comprising: using the apparatus disclosed herein to secure at least one wheel of a wheeled machine between the pair of brackets; and transporting the wheeled machine.

In addition to the embodiments described above, further aspects, examples, and embodiments will become apparent by study of the following descriptions. The summary above is a list of example implementations, not a limiting statement of the scope.

### BRIEF DESCRIPTION OF THE DRAWINGS

The accompanying figures, which are incorporated herein and form a part of the specification, illustrate some, but not the only or exclusive, example embodiments and/or features. It is intended that the embodiments and figures disclosed herein are to be considered illustrative rather than limiting.

FIG. 1 is an exploded view of the wheel retaining apparatus, according to an embodiment.

FIG. 2 is a perspective view of the wheel retaining apparatus illustrated in FIG. 1 in the locked position.

FIG. 3 is a left-side view of the wheel retaining apparatus illustrated in FIG. 1 in the locked position.

FIG. 4 is a right-side view of the wheel retaining apparatus illustrated in FIG. 1 in the locked position.

FIG. 5 is a left-side view of the wheel retaining apparatus, according to an embodiment.

FIG. 6 is a perspective view of one of the brackets showing the two pieces welded together.

FIG. 7 is a side view of the wheel retaining apparatus assembled on the platform of a trailer, retaining the front wheel of a lawn mower.

FIG. 8 is a side view of the wheel retaining apparatus assembled on the platform of a trailer, retaining the front wheel of a motorcycle.

### DETAILED DESCRIPTION

All publications, patents and patent applications referenced herein, including any drawings and appendices, are herein incorporated by reference to the same extent as if each individual publication or patent application was specifically and individually indicated to be incorporated by reference.

The following description includes information that may be useful in understanding the present disclosure. It is not an admission that any of the information provided herein is prior art or relevant to the presently claimed embodiments, or that any publication specifically or implicitly referenced is prior art.

### Definitions

As used in this specification, the singular forms “a,” “an” and “the” include plural referents unless the context clearly dictates otherwise. Thus, for example, the term “a member” is intended to mean a single member or a combination of members, “a material” is intended to mean one or more materials, or a combination thereof. As used herein, the terms “reversible,” “reversibly,” “removably,” and/or the like when used to describe a process and/or procedure generally refer to a non-destructive process or procedure that can be subsequently undone by a similar yet substantially opposed, inverse, and/or opposite non-destructive process or procedure. When used herein with respect to attachment and/or detachment of an element or assembly, a reversible or removable attachment refers to a non-destructive, repeatable attachment and/or detachment of the element or assembly.

As used herein, the terms “about” and/or “approximately” when used in conjunction with numerical values and/or ranges generally refer to those numerical values and/or ranges near to a recited numerical value and/or range. For example, in some instances, “about 40 [units]” can mean within +25% of 40 (e.g., from 30 to 50). In some instances, the terms “about” and “approximately” can mean within +10% of the recited value. In other instances, the terms “about” and “approximately” can mean within +9%, +8%, +7%, +6%, +5%, +4%, +3%, +2%, 1%, less than +1%, or any other value or range of values therein or there below. The terms “about” and “approximately” may be used interchangeably. Furthermore, although a numerical value modified by the term “about” or “approximately” can allow for and/or otherwise encompass a tolerance of the stated numerical value, it is not intended to exclude the exact numerical value stated.

In a similar manner, term “substantially” when used in connection with, for example, a geometric relationship, a numerical value, and/or a range is intended to convey that the geometric relationship (or the structures described thereby), the number, and/or the range so defined is nominally the recited geometric relationship, number, and/or range. For example, two structures described herein as being “substantially parallel” is intended to convey that, although a parallel geometric relationship is desirable, some non-parallelism can occur in a “substantially parallel” arrangement. By way of another example, a structure defining a diameter that is “substantially 100 millimeters (mm)” is intended to convey that, while the recited diameter is desirable, some tolerances can occur when the diameter is “substantially” the recited diameter (e.g., 100 mm). Such tolerances can result from manufacturing tolerances, measurement tolerances, and/or other practical considerations (such as, for example, minute imperfections, age of a structure so defined, a pressure or a force exerted within a system, and/or the like). As described above, a suitable tolerance can be, for example, of ±1%, ±2%, ±3%, ±4%, ±5%, ±6%, ±7%, ±8%, ±9%, ±10%, or more of the stated geometric construction, numerical value, and/or range. Furthermore, although a numerical value modified by the term “substantially” can allow for and/or otherwise encompass a tolerance of the stated numerical value, it is not intended to exclude the exact numerical value stated.

While numerical ranges may be provided for certain quantities, it is to be understood that these ranges can include all subranges therein. Thus, the range “from 5 to 10” includes all possible ranges therein and all values within a given range may be an endpoint for the range encompassed thereby (e.g., 6-10, 7-10, 8-10, 9-10, 5-9, 6-9, 7-9, 8-9, 5-8, 6-8, 7-8, 6-8, 7-8, 8-9, or fractions thereof).

### Overview

The disclosure relates to wheel retaining apparatuses, kits, and methods of using the same. The wheel retaining apparatus may be used to secure and/or transport any number of wheeled machines.

### Wheel Retaining Apparatus

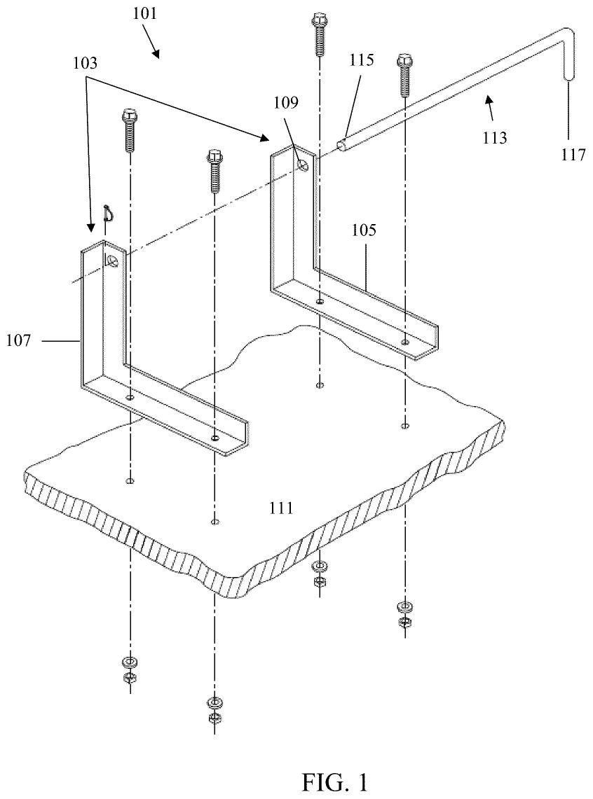

Shown in FIG. 1 is an exploded view of a wheel retaining apparatus 101 for retaining a wheeled machine according to an embodiment. As shown in FIG. 1, the apparatus comprises a pair of brackets 103 each comprising a first channel member 105 with an extended length for positioning on and affixation to a platform 111, and a second channel member 107 affixed to the first channel member and extending out from the first channel member at an angle thereto. In some embodiments, the second channel member 107 of each bracket includes at least one opening 109. The pair of brackets 103 are spaced apart from one another a first distance relative to a platform 111. The distance between the brackets is such that the established space between the brackets is configured to receive at least one wheel of a wheeled machine. When a wheel is placed between the brackets it is prevented from rolling by a retaining rod 113 having a first end 117, a second end 115, and a length. The retaining rod 113 may be curved at the first end 117 and the length is greater than the first distance between the pair of brackets.

The at least one opening 109 of each second channel member 107 is configured to receive and retain the retaining rod 113, such that, upon at least one wheel being received between the pair of brackets 103, the second end of the retaining rod 113 is inserted within the opening 109 and is received within the opening 109 of the second bracket so as to retain the wheel.

Although the at least one opening 109 is shown as a substantially circular in FIG. 1, in some embodiments, the opening 109 can be any suitable shape configured to receive the retaining rod 113 including, but not limited to, circular, substantially circular, oval, polygon, such as a triangle, rectangle, square, pentagon, hexagon, heptagon, octagon, nonagon, or decagon.

In some embodiments, the at least one opening 109 has a diameter of approximately ⅛ inch, ¼ inch, ⅜ inch, ½ inch, ⅝ inch, ¾ inch, ⅞ inch, 1 inch, 1.125 inches, 1.25 inches, 1.375 inches, 1.5 inches, 1.625 inches, 1.75 inches, 1.875 inches, 2 inches, 2.125 inches, 2.25 inches, 2.375 inches, 2.5 inches, 2.625 inches, 2.75 inches, 2.875 inches, 3 inches, and all fractions thereof.

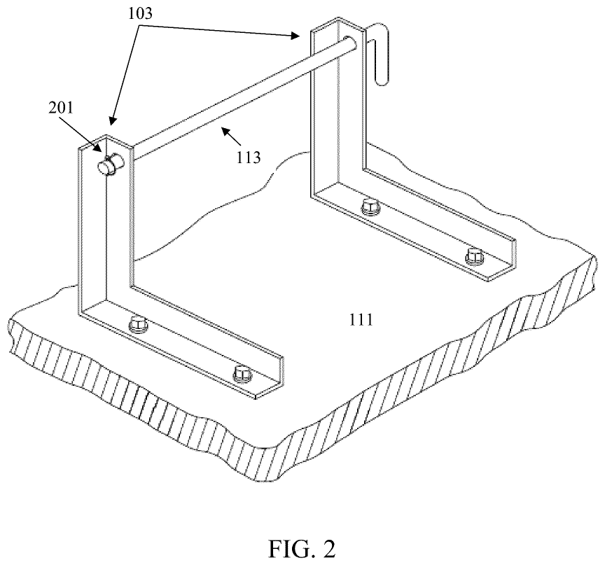

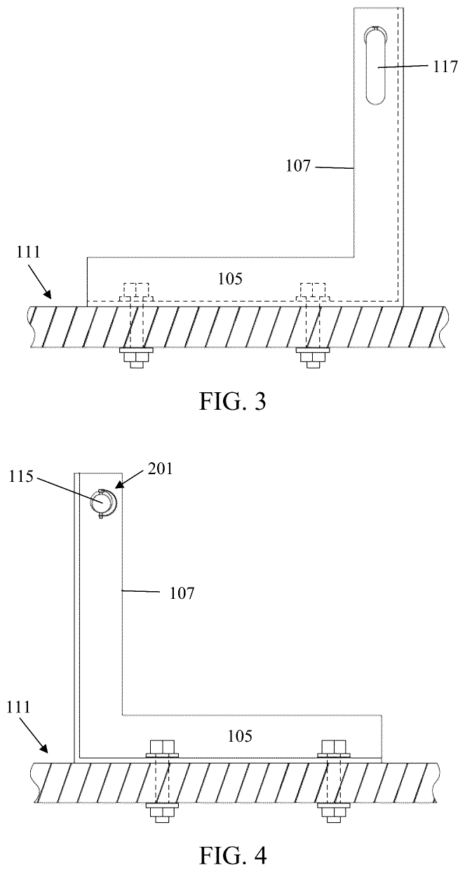

In some embodiments, the retaining rod 113 is secured or locked in place. In some embodiments, the retaining rod 113 is secured or locked in place with a linchpin 201 (FIG. 2). In some embodiments, the retaining rod 113 may be secured or locked in place by a fastener, such as a nut. In some embodiments, the retaining rod 113 may be secured or locked in place by a clip, such as a trigger clip, lobster claw clip, or snap clip. In some embodiments, the retaining rod 113 may be secured or locked in place by a magnet. In some embodiments, the second channel member 107 of each bracket includes a means for releasably coupling a retaining rod 113. In some embodiments, the means for releasably coupling the retaining rod 113 comprises a hook, magnet, trigger clip, lobster claw clip, or snap clip. In some embodiments, both the first end 117 and the second end 115 of the retaining rod 113 may be curved and/or comprise a means for locking or securing in place once releasably coupled to the second channel member 107.

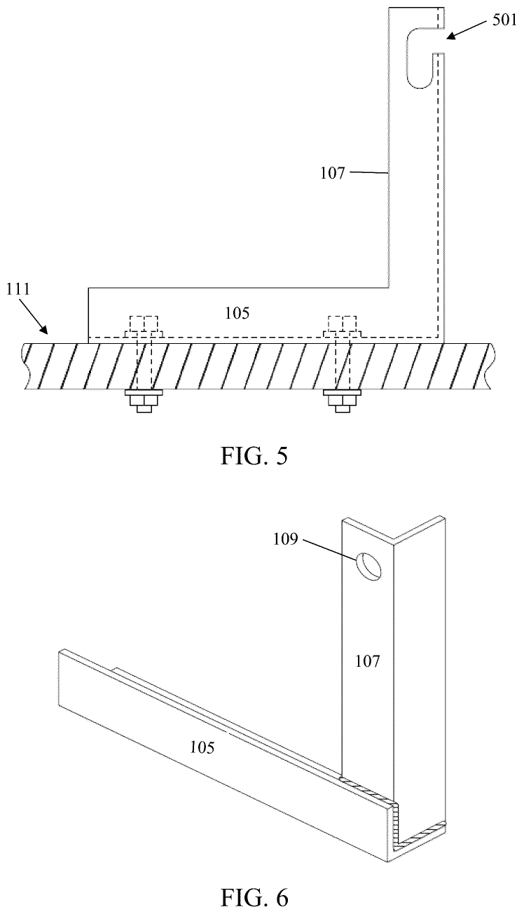

In some embodiments, the at least one opening 109 is a slot. As shown in FIG. 5, in some embodiments, the opening is a slot 501, wherein the retaining rod drops down once inserted and is secured within the second channel member 107.

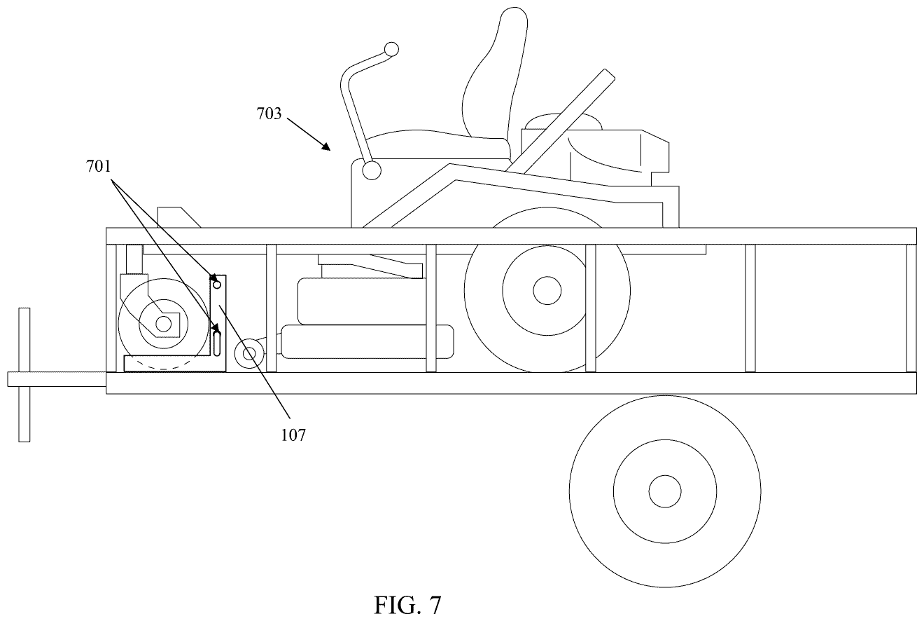

In some embodiments there are two or more openings 701 on the second channel member 107. As will be understood by one skilled in the art, these additional openings may be used to accommodate different wheel heights (see for example FIG. 7) or may be used with two or more retaining rods to secure larger wheels.

In some embodiments, the retaining rod is a rebar. In some embodiments, the retaining rod is composed of carbon steel, stainless steel, galvanized rebar, glass fiber reinforced polymer, epoxy coated rebar, welded wire fabric, or expanded metal.

In some embodiments, the retaining rod has a strength of between about 5,000 psi to 10,000 psi, about 10,001 psi to 20,000 psi, about 20,001 psi to 30,000 psi, about 30,001 psi to 40,000 psi, about 40,001 psi to 50,000 psi, about 50,001 psi to 60,000 psi, about 60,001 psi to 70,000 psi, about 70,001 psi to 80,000 psi, about 80,001 psi to 90,000 psi, about 90,001 psi to 100,000 psi, and all fractions thereof.

In some embodiments, the pair of brackets 103 may comprise reflective material. The reflective material may be comprised of embedded reflective film, sealed reflective film, micro prism reflective film, all prism reflective film, or combinations thereof. The material may be a reflective coating applied to the hardware. The reflective material may be of any color, for example, red, yellow, blue, white, green, orange, or combinations thereof.

In some embodiments, the pair of brackets 103 and/or the retaining rod 113 are padded or wrapped to more securely hold the wheel and/or prevent damage to the wheel. The padding or wrap may be comprised of rubber, foam rubber, neoprene, compressed polyester, polyester fiberfill, medium or high density polyurethane foam, open cell foam, closed cell foam, fabric backed sew foam, polyethylene sheet, polyethylene foam, or equivalents thereof.

In some embodiments, the first channel member 105 has a length of 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, and all fractions thereof.

In some embodiments, the second channel member 107 has a length of 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, 25 inches, 26 inches, 27 inches, 28 inches, 29 inches, 30 inches, 31 inches, 32 inches, 33 inches, 34 inches, 35 inches, 36 inches, and all fractions thereof.

In some embodiments, the ratio of the length of the first channel member to the length of the second channel member is 1:1. In some embodiments, the ratio of the length of the first channel member to the length of the second channel member is between 2:1 and 1:1. In some embodiments, the ratio of the length of the first channel member to the length of the second channel member is between 3:1 and 1:1.

In some embodiments, the ratio of the length of the first channel member to the length of the second channel member is 1:2. In some embodiments, the ratio of the length of the first channel member to the length of the second channel member is between 1:2 and 1:1. In some embodiments, the ratio of the length of the first channel member to the length of the second channel member is between 1:3 and 1:1.

In some embodiments, the second channel member 107 is affixed to the first channel member 105 at an angle of approximately 90 degrees. In some embodiments, the angle is between 80 degrees and 90 degrees. In some embodiments, the angle is 91 degrees, 92 degrees, 93 degrees, 94 degrees, 95 degrees, 96 degrees, 97 degrees, 98 degrees, 99 degrees, 100 degrees, 101 degrees, 102 degrees, 103 degrees, 104 degrees, 105 degrees, 106 degrees, 107 degrees, 108 degrees, 109 degrees, 110 degrees, 111 degrees, 112 degrees, 113 degrees, 114 degrees, 115 degrees, 116 degrees, 117 degrees, 118 degrees, 119 degrees, 120 degrees, 121 degrees, 122 degrees, 123 degrees, 124 degrees, 125 degrees, 126 degrees, 127 degrees, 128 degrees, 129 degrees, 130 degrees, 131 degrees, 132 degrees, 133 degrees, 134 degrees, 135 degrees, 136 degrees, 137 degrees, 138 degrees, 139 degrees, 140 degrees, 141 degrees, 142 degrees, 143 degrees, 144 degrees, 145 degrees, and all fractions thereof.

In some embodiments, the apparatus further comprises a third channel member and a second retaining rod, wherein the third channel member is coupled to the first channel member 105 opposite the second channel member 107, the third channel member including a means for releasably coupling the second retaining rod.

In some embodiments, the first channel member 105 is permanently affixed to the second channel member 107 (FIG. 6, for example, where the first channel member 105 is welded to the second channel member 107). In some embodiments, the first channel member 105 is releasably affixed to the second channel member 107, for example with a fastener, such as a bolt. In some embodiments, the first channel member 105 is operably coupled to the second channel member 107 such that the second channel member 107 can fold down flat or up and lock in place at a certain angle.

In some embodiments, one or both of the brackets 103 are affixed to the platform 111 such that the first distance is adjustable to accommodate different sizes of wheels. In some embodiments, the first distance between the pair of brackets is 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 25 inches, 26 inches, 27 inches, 28 inches, 29 inches, 30 inches, 31 inches, 32 inches, 33 inches, 34 inches, 35 inches, 36 inches, 37 inches, 38 inches, 39 inches, 40 inches, 41 inches, 42 inches, 43 inches, 44 inches, 45 inches, 46 inches, 47 inches, 48 inches, 49 inches, 50 inches, 51 inches, 52 inches, 53 inches, 54 inches, 55 inches, 56, inches, 57 inches, 58 inches, 59 inches, 60 inches, 61 inches, 62 inches, 63 inches, 64 inches, 65 inches, 66 inches, 67 inches, 68 inches, 69 inches, 70 inches, 71 inches, 72 inches, 73 inches, 74 inches, 75 inches, 76 inches, 77 inches, 78 inches, 79 inches, 80 inches, 81 inches, 82 inches, 83 inches, 84, inches, 85 inches, 86 inches, 87 inches, 88 inches, 89 inches, 90 inches, 91 inches, 92 inches, 93 inches, 94 inches, 95 inches, 96 inches, and all fractions thereof.

In some embodiments, the retaining rod has an adjustable length. In some embodiments, the length of the retaining rod is 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 25 inches, 26 inches, 27 inches, 28 inches, 29 inches, 30 inches, 31 inches, 32 inches, 33 inches, 34 inches, 35 inches, 36 inches, 37 inches, 38 inches, 39 inches, 40 inches, 41 inches, 42 inches, 43 inches, 44 inches, 45 inches, 46 inches, 47 inches, 48 inches, 49 inches, 50 inches, 51 inches, 52 inches, 53 inches, 54 inches, 55 inches, 56, inches, 57 inches, 58 inches, 59 inches, 60 inches, 61 inches, 62 inches, 63 inches, 64 inches, 65 inches, 66 inches, 67 inches, 68 inches, 69 inches, 70 inches, 71 inches, 72 inches, 73 inches, 74 inches, 75 inches, 76 inches, 77 inches, 78 inches, 79 inches, 80 inches, 81 inches, 82 inches, 83 inches, 84, inches, 85 inches, 86 inches, 87 inches, 88 inches, 89 inches, 90 inches, 91 inches, 92 inches, 93 inches, 94 inches, 95 inches, 96 inches, 97 inches, 98 inches, 99 inches, 100 inches, and all fractions thereof.

As will be understood by one skilled in the art, a variety of materials may be used to construct the pair of brackets 103, including but not limited to, plastic, steal, metal, or wood.

In some embodiments, the wheel retaining apparatus 101 comprises a platform. In some embodiments, the wheel retaining apparatus 101 comprises two pairs of brackets spaced apart from one another a third distance, the first pair of brackets arranged to retain the first wheel of a wheeled machine and the second pair of brackets arranged to retain a second wheel of the wheeled machine.

In some embodiments, the third distance is between 12-24 inches, between 24-36 inches, between 24-48 inches, between 24-72 inches, between 24-84 inches, between 24-96 inches, between 24-108 inches, and all fractions thereof.

In some embodiments, multiple rows of pairs of brackets may be affixed to a platform to secure any number of wheeled machines placed side-by-side and/or front-to-back on the same platform.

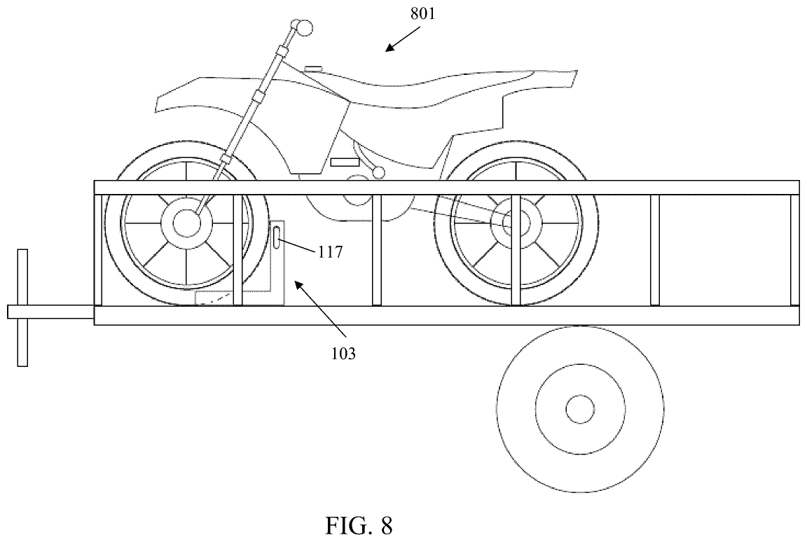

In some embodiments, the pair of brackets 103 or each pair of brackets are affixed to the platform such that they are at least approximately parallel to one another. As shown in FIG. 7 and FIG. 8, the platform may be a trailer (701).

### Wheel Retaining Kits

In some embodiments, the disclosure provides at kit for retaining a wheeled machine on a platform comprising: a first retaining rod having a first end, a second end, and a length; a pair of first and second channel members, wherein each first channel member has an extended length for positioning on and affixation to a platform, and each second channel member has a means for releasably coupling the retaining rod; at least one fastener for affixing each of the first and second channel members together and/or affixing each of the first channel members to the platform; and instructions for installation and use, wherein the instructions comprise directions for: affixing each first and second channel member together at an angle thereto to form a pair of brackets; affixing the second channel member of each bracket to a platform at a distance, orientation, and position so as to retain a wheeled machine when at least one wheel, being received between the pair of brackets, is prevented from rolling backwards when the retaining rod is releasably coupled to each second channel member. In some embodiments, the kit further comprises at least one of a linchpin, bolt, clip, and magnet.

### Methods of use

In some embodiments, the disclosure teaches a method for transporting a wheeled machine comprising using the apparatus or kit disclosed herein and transporting the wheeled machine.

The apparatus, kit, and methods disclosed herein may be used to secure and/or transport any number of wheeled machines. Examples of wheeled machines include, but are not limited to, a push lawn mower, a riding lawn mower, a snow blower, tractors, a wagon, a wheelbarrow, a bicycle, a tricycle, electric toy vehicles, a motorcycle, a dirt bike, a scooter, a 4-wheeler, a golf cart, a car, a truck, a SUV, an ATV, a wheeled excavator, forklift, a skid steer, a backhoe loader, a compactor, and a roller. As will be understood by those skilled in the art, the disclosed wheel retaining apparatus may be customized to the size and shape of any wheeled machine.

### EXAMPLES

The following examples are provided to illustrate further the various applications of the present disclosure and are not intended to limit the disclosure beyond the limitations set forth in the appended claims.

### Example 1—Transporting a Lawn Mower

As shown in FIG. 7, the wheel retaining apparatus may be affixed to the platform of a trailer to transport a lawn mower 703. The pair of brackets are positioned towards the front of the trailer, near the coupler. The front wheels of the lawn mower are positioned in the first distance between the pair of brackets. A retaining rod is then releasably coupled to the pair of brackets, in this example by insertion through the lower of two openings 107 in the second channel member 107 of each of the pair of brackets.

### Example 2—Transporting a Motorcycle

As shown in FIG. 8, the wheel retaining apparatus may be affixed to the platform of a trailer to transport a motorcycle 801. The pair of brackets 103 are positioned towards the front of the trailer, near the coupler. The front wheels of the motorcycle are positioned in the first distance between the pair of brackets 103. A retaining rod having a curved first end 117 is then releasably coupled to the pair of brackets, in this example by insertion through an opening in the second channel member of each of the pair of brackets.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that any and all parameters, dimensions, materials, and configurations described herein are meant to be an example and that the actual parameters, dimensions, materials, and/or configurations will depend upon the specific application or applications for which the inventive teachings disclosed herein is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the claims supported by the disclosure, and equivalents thereto, inventive embodiments may be practiced otherwise than as specifically described and claimed. Inventive embodiments of the present disclosure are also directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Embodiments disclosed herein may also be combined with one or more features, as well as complete systems, devices and/or methods, to yield yet other embodiments and inventions. Moreover, some embodiments, may be distinguishable from the prior art by specifically lacking one and/or another feature disclosed in the particular prior art reference(s); i.e., claims to such embodiments are distinguishable from the prior art by including one or more negative limitations.

Also, various inventive concepts may be embodied as one or more methods. The acts performed as part of the method may be ordered in any suitable way. Accordingly, embodiments may be constructed in which acts are performed in an order different than illustrated, which may include performing some acts simultaneously.

The indefinite articles “a” and “an,” as used herein in the specification and in the claims, unless clearly indicated to the contrary, should be understood to mean “at least one.” The terms “can” and “may” are used interchangeably in the present disclosure, and indicate that the referred to element, component, structure, function, functionality, objective, advantage, operation, step, process, apparatus, system, device, result, or clarification, has the ability to be used, included, or produced, or otherwise stand for the proposition indicated in the statement for which the term is used (or referred to) for a particular embodiment(s).

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### Numbered Embodiments

1. A wheel retaining apparatus for retaining a wheeled machine relative to a platform comprising:
   a rebar having a first end, a second end, and a length;
   and
   a pair of brackets each comprising:
      a first channel member with an extended length for positioning on and affixation to a platform, and
      a second channel member affixed to the first channel member and extending out from the first channel member at an angle thereto;
   wherein:
      the pair of brackets are spaced apart from one another a first distance, the first distance being between 4 and 96 inches;
      the distance between the brackets is such that the established space between the brackets is configured to receive at least one wheel of a wheeled machine;
      the rebar is curved at the first end and the length is greater than the first distance between the pair of brackets;
      the second channel member of each bracket includes at least one opening spaced apart from the base at a second distance;
      the opening of each second channel member is configured to receive and retain the retaining rod, such that, upon at least one wheel being received between the pair of brackets, the second end of the retaining rod is inserted within the opening of a first of the pair of brackets, and then received within the opening of a second of the pair of brackets so as to retain the at least one wheel of the wheeled machine between the pair of brackets.
2. The apparatus of embodiment 1, further comprising a locking mechanism to lock the rebar in place.
3. The apparatus of embodiment 2, wherein the locking mechanism comprises a pin received by an opening within the second end of the rebar.
4. The apparatus of any one of embodiments 1-3, wherein the first channel member and the second channel member are angle iron.
5. The apparatus of any one of embodiments 1-4, wherein the first end of the rebar is bent at a 90 angle.
6. The apparatus of any one of embodiments 1-5, wherein the rebar is between ⅜ of an inch and 1 inch in diameter.
7. The apparatus of any one of embodiments 1-6, wherein the rebar has a minimum yield strength of 40,000 PSI.
8. The apparatus of any one of embodiments 1-7, wherein the rebar is steel.
9. The apparatus of any one of embodiments 1-7, wherein the first distance is between 4 and 12 inches.
10. The apparatus of any one of embodiments 1-7, wherein the first distance is between 12 and 24 inches.
11. The apparatus of any one of embodiments 1-7, wherein the first distance is between 24 and 36 inches.
12. The apparatus of any one of embodiments 1-7, wherein the first distance is between 36 and 48 inches.
13. The apparatus of any one of embodiments 1-7, wherein the first distance is between 48 and 60 inches.
14. The apparatus of any one of embodiments 1-7, wherein the first distance is between 60 and 72 inches.
15. The apparatus of any one of embodiments 1-7, wherein the first distance is between 72 and 84 inches.
16. The apparatus of any one of embodiments 1-7, wherein the first distance is between 84 and 96 inches.
17. The apparatus of any one of embodiments 1-16, wherein the first distance is adjustable.
18. The apparatus of any one of embodiments 1-17, wherein the first channel member is permanently affixed to the second channel member.
19. The apparatus of embodiment 18, wherein the first channel member is affixed to the second channel member at an angle of approximately 90 degrees.
20. The apparatus of any one of embodiments 1-17, wherein the first channel member is releasably affixed to the second channel member.
21. The apparatus of any one of embodiments 1-17, wherein the first channel member is affixed to the second channel member with a hinge to allow the second channel member to fold down flat.
22. The apparatus of embodiment 20 or 21, wherein the affixation comprises a lock to secure the second channel member at an angle.
23. The apparatus of any one of embodiments 20-22, wherein the first channel member is affixed to the second channel member at an angle of between 80 and 145 degrees.
24. The apparatus of any one of embodiments 1-23, wherein the first channel member has a length of between 2 and 6 inches.
25. The apparatus of any one of embodiments 1-23, wherein the first channel member has a length of between 6 and 12 inches.
26. The apparatus of any one of embodiments 1-23, wherein the first channel member has a length of between 12 and 18 inches.
27. The apparatus of any one of embodiments 1-23, wherein the first channel member has a length of between 18 and 24 inches.
28. The apparatus of any one of embodiments 1-23, wherein the second channel member has a length of between 2 and 6 inches.
29. The apparatus of any one of embodiments 1-23, wherein the second channel member has a length of between 6 and 12 inches.
30. The apparatus of any one of embodiments 1-23, wherein the second channel member has a length of between 12 and 18 inches.
31. The apparatus of any one of embodiments 1-23, wherein the second channel member has a length of between 18 and 24 inches.
32. The apparatus of any one of embodiments 1-23, wherein the second channel member has a length of between 24 and 30 inches.
33. The apparatus of any one of embodiments 1-23, wherein the second channel member has a length of between 30 and 36 inches.
34. The apparatus of any one of embodiments 1-23, wherein the ratio of the length of the first channel member to the length of the second channel member is between 1:1 and 1:2.
35. The apparatus of any one of embodiments 1-23, wherein the ratio of the length of the first channel member to the length of the second channel member is between 1:1 and 2:1.
36. The apparatus of any one of embodiments 1-35, wherein the pair of brackets is padded or wrapped with a material to prevent damage to the wheel or machine.
37. The apparatus of any one of embodiments 1-36, wherein the rebar is padded or wrapped with a material to prevent damage to the wheel or machine.
38. The apparatus of embodiment 36 or 37, wherein the material comprises rubber, foam rubber, neoprene, compressed polyester, polyester fiberfill, medium or high density polyurethane foam, open cell foam, closed cell foam, fabric backed sew foam, polyethylene sheet, polyethylene foam, or equivalents thereof.
39. The apparatus of any one of embodiments 1-38, wherein the platform is a trailer.
40. A wheel retaining apparatus for retaining a wheeled machine relative to a platform comprising:
   a first retaining rod having a first end, a second end, and a length;
   and
   a pair of brackets each comprising:
      a first channel member with an extended length for positioning on and affixation to a platform, and
      a second channel member affixed to the first channel member and extending out from the first channel member at an angle thereto;
   wherein:
      the pair of brackets are spaced apart from one another a first distance, the first distance between the brackets is such that the established space between the brackets is configured to receive at least one wheel of a wheeled machine;
      the length of the first retaining rod is greater than the first distance between the pair of brackets;
      the second channel member of each bracket includes a means for releasably coupling the first retaining rod, such that, upon at least one wheel of a wheeled machine being received between the pair of brackets, the first retaining rod is releasably coupled to the second channel member so as to retain the at least one wheel of the wheeled machine between the pair of brackets.
41. The apparatus of embodiment 40, wherein the means for releasably coupling the first retaining rod to the second channel member comprises an opening on the second channel member configured to receive the retaining rod.
42. The apparatus of embodiment 40, wherein the means for releasably coupling the first retaining rod to the second channel member comprises a slot on the second channel member configured to receive the retaining rod.
43. The apparatus of embodiment 42, wherein the slot comprises a first opening of a first size, and a second opening of a second size less than the first size of the first opening, wherein:
   the first opening is configured to initially receive the retaining rod;
   the second opening is configured to receive the retaining rod from the first opening and retain it therein.
44. The apparatus of embodiment 42, wherein the first end and the second end of the retaining rod are curved.
45. The apparatus of any one of embodiments 40-44, further comprising a locking mechanism to lock the first retaining rod in place.
46. The apparatus of embodiment 45, wherein the locking mechanism comprises at least one of a linchpin, nut, clip, and magnet.
47. The apparatus of any one of embodiments 40-46, wherein the retaining rod length is adjustable.
48. The apparatus of any one of embodiments 40-46, wherein the retaining rod is a rebar.
49. The apparatus of any one of embodiments 40-48, wherein the retaining rod is between ⅜ of an inch and 1 inch in diameter.
50. The apparatus of any one of embodiments 40-49, wherein the retaining rod has a minimum yield strength of 40,000 PSI.
51. The apparatus of any one of embodiments 40-50, wherein the retaining rod is steel.
52. The apparatus of any one of embodiments 40-51, wherein the first distance is between 4 and 12 inches.
53. The apparatus of any one of embodiments 40-51, wherein the first distance is between 12 and 24 inches.
54. The apparatus of any one of embodiments 40-51, wherein the first distance is between 24 and 36 inches.
55. The apparatus of any one of embodiments 40-51, wherein the first distance is between 36 and 48 inches.
56. The apparatus of any one of embodiments 40-51, wherein the first distance is between 48 and 60 inches.
57. The apparatus of any one of embodiments 40-51, wherein the first distance is between 60 and 72 inches.
58. The apparatus of any one of embodiments 40-51, wherein the first distance is between 72 and 84 inches.
59. The apparatus of any one of embodiments 40-51, wherein the first distance is between 84 and 96 inches.
60. The apparatus of any one of embodiments 40-59, wherein the first distance is adjustable.
61. The apparatus of any one of embodiments 40-60, wherein the first channel member is permanently affixed to the second channel member.
62. The apparatus of embodiment 61, wherein the first channel member is affixed to the second channel member at an angle of approximately 90 degrees.
63. The apparatus of any one of embodiments 40-60, wherein the first channel member is releasably affixed to the second channel member.
64. The apparatus of any one of embodiments 40-60, wherein the first channel member is affixed to the second channel member with a hinge to allow the second channel member to fold down flat.
65. The apparatus of embodiment 63 or 64, wherein the affixation comprises a lock to secure the second channel member at an angle.
66. The apparatus of any one of embodiments 63-65, wherein the first channel member is affixed to the second channel member at an angle of between 80 and 145 degrees.
67. The apparatus of any one of embodiments 40-66, wherein the first channel member has a length of between 2 and 6 inches.
68. The apparatus of any one of embodiments 40-66, wherein the first channel member has a length of between 6 and 12 inches.
69. The apparatus of any one of embodiments 40-66, wherein the first channel member has a length of between 12 and 18 inches.
70. The apparatus of any one of embodiments 40-66, wherein the first channel member has a length of between 18 and 24 inches.
71. The apparatus of any one of embodiments 40-66, wherein the second channel member has a length of between 2 and 6 inches.
72. The apparatus of any one of embodiments 40-66, wherein the second channel member has a length of between 6 and 12 inches.
73. The apparatus of any one of embodiments 40-66, wherein the second channel member has a length of between 12 and 18 inches.
74. The apparatus of any one of embodiments 40-66, wherein the second channel member has a length of between 18 and 24 inches.
75. The apparatus of any one of embodiments 40-66, wherein the second channel member has a length of between 24 and 30 inches.
76. The apparatus of any one of embodiments 40-66, wherein the second channel member has a length of between 30 and 36 inches.
77. The apparatus of any one of embodiments 40-66, wherein the ratio of the length of the first channel member to the length of the second channel member is between 1:1 and 1:2.
78. The apparatus of any one of embodiments 40-66, wherein the ratio of the length of the first channel member to the length of the second channel member is between 1:1 and 2:1.
79. The apparatus of any one of embodiments 40-78, wherein the pair of brackets is padded or wrapped with a material to prevent damage to the wheel or machine.
80. The apparatus of any one of embodiments 40-79, wherein the retaining rod is padded or wrapped with a material to prevent damage to the wheel or machine.
81. The apparatus of embodiment 79 or 80, wherein the material comprises rubber, foam rubber, neoprene, compressed polyester, polyester fiberfill, medium or high density polyurethane foam, open cell foam, closed cell foam, fabric backed sew foam, polyethylene sheet, polyethylene foam, or equivalents thereof.
82. The apparatus of any one of embodiments 40-81, wherein the platform is a trailer.
83. The apparatus of any one of embodiments 1-82, further comprising the platform.
84. The apparatus of embodiment 83, wherein the platform includes two pairs of brackets spaced apart from one another at a third distance, a first pair of brackets arranged to retain a first wheel of the wheeled machine and a second pair of brackets arranged to retain a second wheel of the wheeled machine.
85. The apparatus of embodiment 84, wherein the third distance is between approximately 24-84 inches.
86. The apparatus of embodiment 84 or 85, wherein each pair of brackets are affixed to the platform such that they are at least approximately parallel to one another.
87. The apparatus of any one of embodiments 1-86, wherein the second channel member includes a length such that a distal end thereof is spaced approximately 6-10 inches away from the platform.
88. The apparatus of any one of embodiments 1-88, further comprising a third channel member and a second retaining rod, wherein the third channel member is coupled to first channel member opposite the second channel member, the third channel member including a means for releasably coupling the second retaining rod.
89. The apparatus of embodiment 88, further comprising a locking mechanism to lock the second retaining rod in place.
90. The apparatus of embodiment 89, wherein the locking mechanism comprises at least one of a linchpin, bolt, clip, and magnet.
91. The apparatus of any one of embodiments 83-90, wherein the platform comprises a portion of a trailer configured to carry wheeled machines.
92. A kit for retaining a wheeled machine on a platform comprising:
   a first retaining rod having a first end, a second end, and a length;
   a pair of first and second channel members, wherein each first channel member has an extended length for positioning on and affixation to a platform, and each second channel member has a means for releasably coupling the retaining rod;
   at least one fastener for affixing each of the first and second channel members together and/or affixing each of the first channel members to the platform; and
   instructions for installation and use, wherein the instructions comprise directions for:
      affixing each first and second channel member together at an angle thereto to form a pair of brackets;
      affixing the second channel member of each bracket to a platform at a distance, orientation, and position so as to retain a wheeled machine when at least one wheel, being received between the pair of brackets, is prevented from rolling backwards when the retaining rod is releasably coupled to each second channel member.
93. The kit of embodiment 92, wherein the first end and the second end of the retaining rod are curved.
94. The kit of any one of embodiments 92-94, further comprising a locking mechanism to lock the first retaining rod in place.
95. The kit of embodiment 94, wherein the locking mechanism comprises at least one of a linchpin, nut, clip, and magnet.
96. The kit of any one of embodiments 92-95, wherein the retaining rod length is adjustable.
97. The kit of any one of embodiments 92-95, wherein the retaining rod is a rebar.
98. The kit of any one of embodiments 92-97, wherein the retaining rod is between ⅜ of an inch and 1 inch in diameter.
99. The kit of any one of embodiments 92-98, wherein the retaining rod has a minimum yield strength of 40,000 PSI.
100. The kit of any one of embodiments 92-99, wherein the retaining rod is steel.
101. The kit of any one of embodiments 92-100, further comprising hardware to allow a user to adjust the distance between the brackets.
102. The kit of any one of embodiments 92-101, comprising a means to permanently affix the first channel member to the second channel member.
103. The kit of any one of embodiments 92-102, comprising a means to releasably affix the first channel member to the second channel member.
104. The kit of any one of embodiments 92-103, comprising a hinge to allow that when affixed to the first and second channel members, allows the second channel member to fold down flat.
105. The kit of embodiment 103 or 104, comprising a lock to secure the second channel member at an angle.
106. The kit of any one of embodiments 92-105, wherein the first channel member has a length of between 2 and 6 inches.
107. The kit of any one of embodiments 92-105, wherein the first channel member has a length of between 6 and 12 inches.
108. The kit of any one of embodiments 92-105, wherein the first channel member has a length of between 12 and 18 inches.
109. The kit of any one of embodiments 92-105, wherein the first channel member has a length of between 18 and 24 inches.
110. The kit of any one of embodiments 92-105, wherein the second channel member has a length of between 2 and 6 inches.
111. The kit of any one of embodiments 92-105, wherein the second channel member has a length of between 6 and 12 inches.
112. The kit of any one of embodiments 92-105, wherein the second channel member has a length of between 12 and 18 inches.
113. The kit of any one of embodiments 92-105, wherein the second channel member has a length of between 18 and 24 inches.
114. The kit of any one of embodiments 92-105, wherein the second channel member has a length of between 24 and 30 inches.
115. The kit of any one of embodiments 92-105, wherein the second channel member has a length of between 30 and 36 inches.
116. The kit of any one of embodiments 40-78, further comprising material to pad or wrap the brackets and/or retaining rod.
117. The kit of embodiment 116, wherein the material comprises rubber, foam rubber, neoprene, compressed polyester, polyester fiberfill, medium or high density polyurethane foam, open cell foam, closed cell foam, fabric backed sew foam, polyethylene sheet, polyethylene foam, or equivalents thereof.
118. A method for transporting a wheeled machine comprising:
   using the apparatus of any one of embodiments 1-91 to secure at least one wheel of a wheeled machine between the pair of brackets; and
   transporting the wheeled machine.
119. The method of embodiment 118, wherein the wheeled machine is a lawn mower.
120. The method of embodiment 118, wherein the wheeled machine is a bicycle.
121. The method of embodiment 118, wherein the wheeled machine is an all-terrain vehicle.
122. The method of embodiment 118, wherein the wheeled machine is a four-wheeler.
123. The method of embodiment 118, wherein the wheeled machine is a motorcycle.
124. The method of embodiment 118, wherein the wheeled machine is a car.

1. A wheel retaining apparatus for retaining a wheeled machine relative to a platform comprising:
a first retaining rod having a first end, a second end, and a length;
and
a pair of brackets each comprising:
a first channel member with an extended length for positioning on and affixation to a platform, and
a second channel member affixed to the first channel member and extending out from the first channel member at an angle thereto;
wherein:
the pair of brackets are spaced apart from one another a first distance, the first distance between the brackets is such that the established space between the brackets is configured to receive at least one wheel of a wheeled machine;
the length of the first retaining rod is greater than the first distance between the pair of brackets;
the second channel member of each bracket includes a means for releasably coupling the first retaining rod, such that, upon at least one wheel of a wheeled machine being received between the pair of brackets, the first retaining rod is releasably coupled to the second channel member so as to retain the at least one wheel of the wheeled machine between the pair of brackets.

2. The apparatus of claim 1, wherein the means for releasably coupling the first retaining rod to the second channel member comprises an opening on the second channel member configured to receive the retaining rod.

3. The apparatus of claim 1, wherein the means for releasably coupling the first retaining rod to the second channel member comprises a slot on the second channel member configured to receive the retaining rod.

4. The apparatus of claim 3, wherein the slot comprises a first opening of a first size, and a second opening of a second size less than the first size of the first opening, wherein:
the first opening is configured to initially receive the retaining rod;
the second opening is configured to receive the retaining rod from the first opening and retain it therein.

5. The apparatus of claim 3, wherein the first end and the second end of the retaining rod are curved.

6. The apparatus of claim 1, further comprising a locking mechanism to lock the first retaining rod in place.

7. The apparatus of claim 6, wherein the locking mechanism comprises at least one of a linchpin, nut, clip, and magnet.

8. The apparatus of claim 1, wherein the retaining rod length is adjustable.

9. The apparatus of claim 1, wherein the retaining rod is rebar.

10. The apparatus of claim 1, wherein the retaining rod is between ⅜ of an inch and 1 inch in diameter.

11. The apparatus of claim 1, wherein the retaining rod has a minimum yield strength of 40,000 PSI.

12. The apparatus of claim 1, further comprising the platform.

13. The apparatus of claim 12, wherein the platform includes two pairs of brackets spaced apart from one another at a third distance, a first pair of brackets arranged to retain a first wheel of the wheeled machine and a second pair of brackets arranged to retain a second wheel of the wheeled machine.

14. The apparatus of claim 13, wherein the third distance is between approximately 24-84 inches.

15. The apparatus of claim 13, wherein each pair of brackets are affixed to the platform such that they are at least approximately parallel to one another.

16. The apparatus of claim 1, wherein the second channel member includes a length such that a distal end thereof is spaced approximately 6-10 inches away from the platform.

17. The apparatus of claim 1, wherein the platform comprises a portion of a trailer configured to carry wheeled machines.

18. The apparatus of claim 1, wherein the first distance is between 4 and 96 inches.

19. A kit for retaining a wheeled machine on a platform comprising:
a first retaining rod having a first end, a second end, and a length;
a pair of first and second channel members, wherein each first channel member has an extended length for positioning on and affixation to a platform, and each second channel member has a means for releasably coupling the retaining rod;
at least one fastener for affixing each of the first and second channel members together and/or affixing each of the first channel members to the platform; and
instructions for installation and use, wherein the instructions comprise directions for:
affixing each first and second channel member together at an angle thereto to form a pair of brackets;
affixing the second channel member of each bracket to a platform at a distance, orientation, and position so as to retain a wheeled machine when at least one wheel, being received between the pair of brackets, is prevented from rolling backwards when the retaining rod is releasably coupled to each second channel member.

20. A method for transporting a wheeled machine comprising:
using the apparatus of claim 1 to secure at least one wheel of a wheeled machine between the pair of brackets; and
transporting the wheeled machine.
